(19) United States
(12) Patent Application Publication
(10) Pub. No.: US 2014/0376371 A1
(43) Pub. Date: Dec. 25, 2014

(54) Method and Device for Conveying Data Across at Least Two Domains

(71) Applicant: Nokia Solutions and Networks Oy, Espoo (FI)

(72) Inventors: Hannu Flinck, Helsinki (FI); Tapio Sakari Partti, Helsinki (FI)

(21) Appl. No.: 14/370,245

(22) PCT Filed: Jan. 2, 2012
(86) PCT No.: PCT/EP2012/050016

§ 371 Date: Jul. 2, 2014

(51) Int. Cl. H04L 12/857; H04L 12/725; H04L 12/803

(52) U.S. Cl. CPC H04L 47/2491; H04L 47/125; H04L 45/302
USPC 370/230

(57) ABSTRACT

A Method and device for conveying data across at least two domains A method and a device for conveying data across at least two domains are provided, wherein at least one service is advertised across the at least two domains; wherein the at least one service is requested across the at least two domains; wherein the at least one service is utilized across the at least two domains. Furthermore, a communication system is suggested comprising said device.

The invention relates to a method and to a device for conveying data across at least two domains. Method and device are preferably used to provide multi-domain QoS enabled services in a communication network. Also, an according communication system is suggested.

### BACKGROUND OF THE INVENTION

Current internet solutions are basically composed of autonomous systems (also referred to as domains or network domains), which are interconnected via links between related domain edge nodes. Owners of autonomous systems are free to choose how their internal networks are built and operated. Usually this will comprise a structure built from network elements (nodes) and interconnection links. However, for inter-operability reasons, autonomous systems are required to use a common protocol, e.g. a border gateway protocol (BGP) as e.g. defined in RFC 4271, “A Border Gateway Protocol 4 (BGP-4)”, which enables inter-domain routing information exchange. Structures and internal operations within the different domains are often kept a secret. Hence, network topology and traffic engineering attributes such as bandwidth, latency and jitter of any network segment are usually not shared among different domains. Traditional unconstrained destination based routing only needs reachability information as usually distributed by conventional routing protocols like e.g. the above mentioned BGP-4. However, for an automatic inter-domain traffic engineered (TE) path reservation system to be able to work reliably and efficiently, some more information from other domains is required.

A meaningful multi-constrained TE-path calculation that is conducted within a single domain needs detailed information about the network topology and TE-attributes of every network segment of the domain that may be utilized for such a path. Therefore, TE information needs either to be distributed inside the domain or it may be collected and conveyed to a point of contact for control such as e.g. a Service Management System (SMS), a Network Management System (NMS) or a Path Computation Element (PCE).

On the other hand, intra-domain paths are in practice either set up via a network management hierarchy or signaled via a control plane using a signaling protocol (e.g. RSVP-TE). Network management hierarchy is a typical way to manage large networks and it usually consists of at least one NMS and multiple Element Management Systems (EMS), but can also leverage a Service Management System (SMS) to manage services. The SMS is on top of the hierarchy controlling at least one NMS, which again controls EMSs that are used to gather information from network nodes and to configure them.

BGP routers exchange UPDATE messages with both intra-domain (using iBGP) and inter-domain (using eBGP) peers to advertize connectivity information in a format of path vectors. Path vectors carry information about destination prefixes, autonomous system (AS) numbers along the path, and other mandatory and optional attributes that enable a decision about the useability and potential preferability of a route. Only the best route to every known destination is advertized further and multiple prefixes that are close to each other can be aggregated into a prefix with a larger scope.

Network and service providers and other instances using internet type infrastructures need to form multi-domain TE-paths in order to provide their customers with Quality of Service (QoS) enabled services across multiple domains. Currently, the setup of such paths is a burdensome task including negotiations, Service Level Agreements (SLA) and static configuration of routers. It can consume a significant amount of time and resources, which makes it slow, static and inefficient, and this limits its useability.

Dynamic provisioning via a control plane (CP) or a management plane (MP) would be preferable, but to efficiently deploy such a system requires that the current inter-domain model and infrastructure is taken into account and as far as possible preserved. In that, each domain may internally be structured and operated differently from each other domain with an inter-domain routing protocol as the only common denominator and glue.

It is thus an object of the invention to enable an automatic and dynamic setup of multi-domain, multi-constrained TE paths spanning several domains, wherein each domain can select, calculate and allocate its intra-domain portion of the path and related resources according to its own internal structure and mode of operation.

### SUMMARY OF THE INVENTION

The object is achieved by a method and device for conveying data across at least two domains
wherein at least one service is advertised across the at least two domains;
wherein the at least one service is requested across the at least two domains;
wherein the at least one service is utilized across the at least two domains.

The service may comprise any service class or any quality of service (QoS) or any other characteristics that may advantageously be utilized beyond a single domain. For example, the solution suggested allows setting up a communication path that supports a particular type of service, characterized e.g. by bandwidth and/or data rate requirements, delay, delay jitter and/or price constraints, reliability and availability expectations, etc., across domains, which could be maintained and operated separate from each other and in a completely different way.

Hence, the solution presented allows adjacent domains to use different techniques to form intra-domain TE-paths, whereas an inter-domain communication path can be determined based on network element types and implementations that are currently present in a vast majority of domains.

A related service may span across more than two domains, starting from an originating domain, passing one or more intermediate domains and ending at a destination domain. The service further may be a point-to-point, a point-to-multipoint, a multipoint-to-point, or a multipoint-to-multipoint service, and thus the at least two domains may comprise one or more originating and/or destination domains. Originating and destination domains are also called end domains of the respective service.

As any domain may take any of the roles of an end domain or an intermediate domain simultaneously, however only for different services and/or different service requests at a time, the following terminology is used throughout this specification and in the appended claims:

A domain denoted as a “first domain” has the role of a domain that initiates the advertising of a service and consequently is the destination domain of a request for that service. As such, a first domain also initiates the acceptance procedure in response to a successful service request. More details on the role, the tasks and activities of a first domain can be derived from the subsequent part of this specification.

A domain denoted as a “second domain” acts as an intermediate domain. It registers service advertisements received from first domains and forwards the service advertisements to further (second or third) domains. A second domain also registers service requests received from third (or other second) domains and forwards them to further domains in the direction towards the first domain, that advertised the related service. A second domain further receives and forwards request acceptance information originated from a first domain and destined to a third domain. More details on the role, the tasks and activities of a second domain can be derived from the subsequent part of this specification.

A domain denoted as a “third domain” receives and registers service advertisements originated by first domains and potentially forwarded by second domains. It receives path requests from users, selects suitable services and forwards related service requests in the direction towards the related first domains that advertised the respective services. In general the role of a third domain is that of an originating domain for a service request. More details on the role, the tasks and activities of a third domain can be derived from the subsequent part of this specification.

As mentioned above, a domain may simultaneously have different roles for different services.

The roles of a first, a second, and a third domain are exemplarily used throughout the subsequent part of this specification as well as in the appended claims. More specifically an arrangement comprising exactly one of each of the three types of domain roles is used in order to explain and illustrate the different roles and functions of domains in the context of the method and system disclosed.

Obviously, a scenario with “at least two domains” does not necessarily have to comprise all three types of domains as specified above. As an example a scenario without a second domain is easily imaginable. However, any person reasonably skilled in the art can in the same way imagine scenarios with more than three domains as well. Once the three types of domain roles and their behaviors are defined, it is an easy engineering task to implement related configurations with a multiplicity of domains including services with multipoint topologies as outlined above.

In an embodiment, the at least one service is utilized across the at least two domains by accepting the request directed towards the at least one service and by configuring a path across the network elements within each domain and between the domains. Inter-domain path segments may use pre-installed interconnection links between domain edge nodes.

In case a service request cannot be served, e.g. if a domain cannot provide a path and/or the resources required by the requested service, or if a service request expires due to a late or missing response, or if a requested service is outdated, or if anything else goes wrong throughout a service request or path setup phase, the domain that detects the problem sends a reject information towards the other domains involved in the service request. A domain receiving a reject information releases potentially reserved resources and removes the related service from its databases, and, if it was not the originating domain of the related request, forwards the reject information to other domains involved. If the originating domain can find a next best route candidate, it can try to establish a new path without consulting the requesting user.

As an option, the service offered (and e.g. its price) can be verified with the requestor, e.g. a user connected to the originating domain, prior to the final establishment and the usage of a path.

It is noted that the path can be set up in a different way and e.g. using different methods and means within each domain along a single inter-domain path.

In another embodiment, the at least one service is advertised, requested and/or utilized by conveying messages of an inter-domain routing protocol between the at least two domains.

It is in particular suggested to use the inter-domain routing protocol for service advertisement as well as for service requesting and service acceptance/rejection functionalities, wherein the messages of the inter-domain routing protocol specify the at least one service using a service template.

In a further embodiment, the inter-domain routing protocol is based on a border gateway protocol. The inter-domain routing protocol may in particular be based on the BGP as set forth in RFC 4271. The BGP can be amended to meet the requirements suggested herein. It is in particular noted that attributes of the BGP can be used for conveying templates that allow for advertising and utilizing services across the borders between (at least two) domains.

More specifically the BGP UPDATE message can be extended with an optional and non-transitive attribute called “eBGP service” so that it can carry service templates, TE-path request templates and/or request accept or request reject templates from adjacent domains. These templates may carry detailed information regarding the service each domain is advertising, requesting, accepting or rejecting via a specific BGP router on its border (also referred to as an edge node). Elements such as a destination information, a price information, and/or one or more QoS attributes such as a bandwidth, delay and/or delay jitter can be included in the template.

It is thus also an embodiment that the at least one service is advertised between the domains by utilizing a service template that is in particular conveyed via a BGP UPDATE message. In a further embodiment, the at least one service is requested between the domains by utilizing a service template that is in particular conveyed via a BGP UPDATE message. In yet another embodiment, the at least one service is accepted between the domains by utilizing a service template that is in particular conveyed via a BGP UPDATE message. It is thus a valid option that the messages of the inter-domain routing protocol are BGP UPDATE messages.

In a next embodiment,
the at least one service is advertised by a control entity of a first domain via at least one edge node of the first domain to at least one first edge node of a second domain;
the at least one first edge node of the second domain informs a control entity of the second domain about the at least one advertised service from the first domain;
the control entity of the second domain advertises the at least one service via at least one second edge node of the second domain to at least one edge node of a third domain;
the at least one edge node of the third domain informs a control entity of the third domain about the at least one advertised service from the first domain.

As explained above, this embodiment covers the exemplary case of a service advertising spanning over exactly three domains, each one of them representing one of the three roles of a first, a second, and a third domain. A person reasonably skilled in the art will easily be able to adapt this example to secenarios with either two domains only, i.e. when there is no second domain, or with more than three domains, i.e. when it spans over more than one domain of the second type. In the same easy way scenarios with multipoint topology services can be adopted.

Pursuant to another embodiment,
a path request is received by a control entity of the third domain;
a service of the at least one advertised service (at least one of the advertised services) is selected and a path across the third domain is determined (in particular selected and/or reserved) by the control entity of the third domain;
a service request is conveyed by the control entity of the third domain via the at least one edge node to the at least one second edge node of the second domain;
the service request is forwarded from the at least one second edge node of the second domain to a control entity of the second domain;
a service (at least one of the advertised services) is selected at the control entity of the second domain and a path across the second domain is determined (in particular selected and/or reserved) by the control entity of the second domain;
a service request is conveyed by the control entity of the second domain via the at least one first edge node of the second domain to the at least one edge node of the first domain;
the service request is forwarded from the at least one edge node of the first domain to a control entity of the first domain;
the control entity of the first domain determines (in particular selects and/or reserves) a path across the first domain.

The path request, especially if it is a TE-path request, usually provides information with respect to specific requirements of the related service, that needs the path. Such requirements may comprise bandwidth or data throughput, QoS parameters, reliability and/or availability levels of the service, etc. Thus the control entity of the third domain, which for that request takes the role of an originating domain, can select an appropriate service and convey a related service request towards the second domain. The control entity of each subsequent domain involved can select a related service and determine a path across the respective domain. Hence, after the service requesting phase a path across the domains as well as within the domains is selected (reserved).

Again, the embodiment described covers the exemplary case of a scenario spanning over exactly three domains, each one of them representing one of the three roles of a first, a second, and a third domain. A person reasonably skilled in the art will easily be able to adapt this example to secenarios with either two domains only, i.e. when there is no second domain, or with more than three domains, i.e. when it spans over more than one domain of the second type. In the same easy way scenarios with multipoint topology services can be adopted.

According to another embodiment,
an accept service request is conveyed by the control entity of the first domain via the at least one edge node of the first domain to the at least one first edge node of the second domain;
the at least one first edge node of the second domain forwards the accept service request to a control entity of the second domain;
an accept service request is conveyed by the control entity of the second domain via the at least one second edge node of the second domain to the at least one edge node of the third domain;
the at least one edge node of the third domain forwards the accept service request to a control entity of the third domain.

Once the accept service request information has arrived at the control entity of the third domain the path can be finally established and committed for use by the requestor.

As before, this embodiment as well covers the exemplary case of a scenario spanning over exactly three domains, each one of them representing one of the three roles of a first, a second, and a third domain. A person reasonably skilled in the art will easily be able to adapt this example to secenarios with either two domains only, i.e. when there is no second domain, or with more than three domains, i.e. when it spans over more than one domain of the second type. In the same easy way scenarios with multipoint topology services can be adopted.

According to a next embodiment, the service template comprises at least one of the following:
a destination information;
price or cost information;
channel characteristics;
bandwidth information;
information regarding the service or quality of service provided or requested;
information regarding a domain;
delay information;
delay jitter information;
traffic information.

Pursuant to yet an embodiment, the intra-domain path in the first domain, in the second domain and in the third domain is set up via the respective control entity or via a signaling protocol.

Hence, the respective control entity may configure an intra-domain path by setting up the data plane and configuring the nodes of the domain accordingly. It is also an option that a signaling protocol can be used (e.g., RSVP-TE) for setting up the intra-domain path.

According to an embodiment, the control entity is at least one of the following:
a network management system,
an element management system,
a service management system,
a domain controller.

A domain controller may be a separate entity, but may as well be implemented as, or as a part of, or incorporated in, e.g. a PCE, a resource manager and/or admission controller, a policy controller, a control unit of a network element, or any other control entity associated with the domain.

The problem stated above is also solved by a device for conveying data across at least two domains, comprising a processing unit that is arranged
for advertising at least one service across the at least two domains,
for utilizing the at least one service advertised across the at least two domains pursuant to a service request that is in particular based on the service advertisement.

In a specific embodiment the processing unit is arranged to execute the method steps of at least one of a control entity of a first, a second, or a third domain as specified above. It is again noted, that a domain may simultaneously assume the roles of all three types of domains, i.e. first, second, and third domain, for different services. Thus the processing unit is to be arranged to act accordingly.

The problem stated above is also solved by a device for conveying data across at least two domains, comprising a processing unit that is arranged
for requesting at least one service that has been advertised across the at least two domains;
for conveying data via a path across the at least two domains, wherein said path has been set up pursuant to the service request.

It is noted that within the at least two domains the advertising domain of a service is usually (but not necessarily) different from the service requesting domain and that it potentially conveys the advertisement via at least one intermediate domain. Accordingly, the service requesting domain may potentially convey the service request via at least one intermediate domain.

It is further noted that the steps of the method stated herein may be executable on the respective processing unit.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

In addition, the problem stated above is solved by a computer-readable medium, e.g., a non-volatile storage of any kind, having computer-executable instructions adapted to, when loaded to its memory, cause a computer system to perform the method as described herein.

Also, the problem stated above is solved by a communication system comprising a first domain, a second domain and a third domain,
wherein at least one service is advertised by the first domain to the third domain via the second domain;
wherein the third domain requests the at least one service or a portion thereof from the first domain via the second domain;
wherein the at least one service requested is accepted or denied by the first domain via the second domain.

It is again mentioned, that the invention is described herein using the best suited configuration comprising three domains, but that a person reasonably skilled in the art would easily be able to implement related equivalents with only two or with more than three domains. Thus a second domain (i.e. a domain of the type “second domain” as specified above) does not necessarily have to be present, or more than one domain of any type may be involved.

Furthermore, the problem stated above is solved by a communication system comprising at least one device as described herein.

### BRIEF DESCRIPTION OF THE DRAWINGS

Embodiments of the invention are shown and illustrated in the following figures:

FIG. 1 shows a schematic diagram visualizing an advertising phase of services from a domain A to a domain C via a domain B;

FIG. 2 shows a schematic diagram visualizing a service requesting phase and a path calculation phase that may follow after the steps as shown and explained with regard to FIG. 1;

FIG. 3 shows a schematic diagram visualizing a service acceptance phase and a path setup phase that may follow after the steps as shown and explained with regard to FIG. 2;

FIG. 4 shows a schematic diagram comprising three interconnected domains and an example for their management hierarchy;

FIG. 5 shows a schematic message chart visualizing the domains according to FIG. 1, FIG. 2 and FIG. 3;

FIG. 6 shows a table comprising an exemplary template with information of a service request or a service offer;

FIG. 7 shows a table comprising exemplary fields of a template.

### DETAILED DESCRIPTION OF THE PREFERRED EMBODIMENT

The solution presented herein may in particular be based on the border gateway protocol (BGP) or the like or it may be based on any inter-domain routing protocol that could be utilized for interconnected domains.

The approach in particular utilizes the inter-domains routing protocol's functionality to interconnect at least two separate domains. Each domain may be maintained by a different operator or provider and it may comprise at least one connection segment.

It is suggested to use the inter-domain routing protocol for service advertisement as well as for service requesting and service acceptance functionalities.

For a better understanding it is noted, that the figures use the name “Domain C” for a “first domain”, “Domain B” for a “second domain”, and “Domain A” for a “third domain” as specified above.

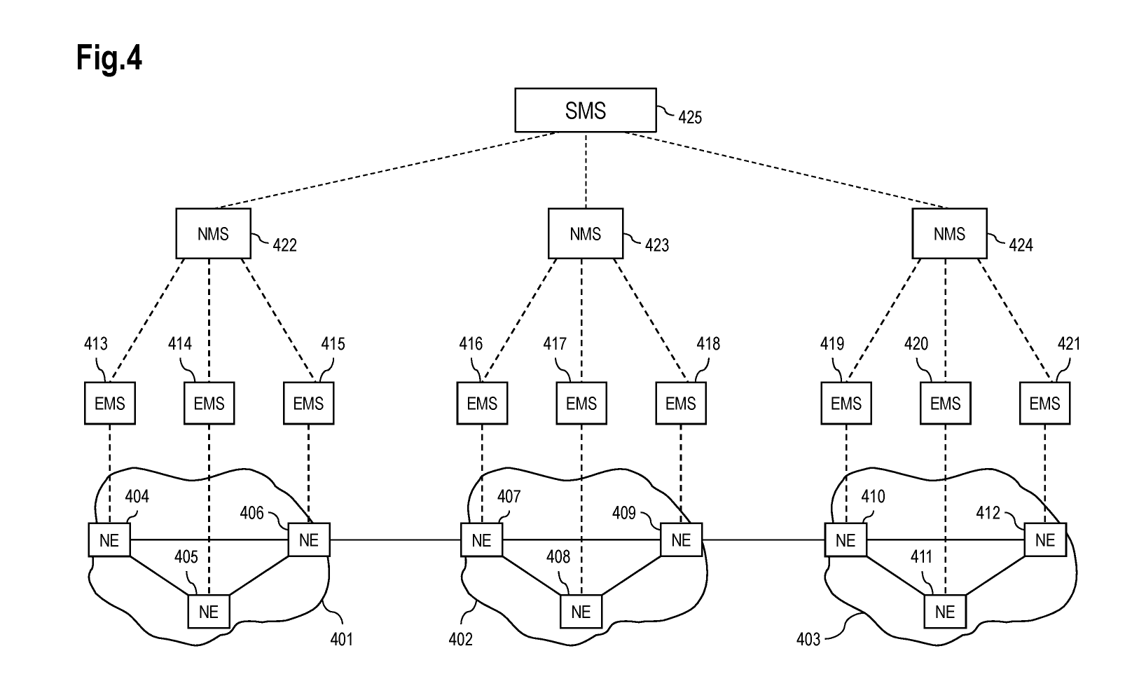

FIG. 4 shows a schematic diagram comprising three interconnected domains 401 to 403.

The domain 401 comprises three network elements 404 to 406, wherein the network element 404 is connected to the network elements 405 and 406 and the network element 405 is further connected to the network element 406. The network elements 404 and 406 are network elements at the edge of the domain 401 and could be realized as edge routers that are based on BGP. The domain 402 comprises three network elements 407 to 409, wherein the network element 407 is connected to the network elements 408 and 409 and the network element 408 is further connected to the network element 409. The network elements 407 and 409 are network elements at the edge of the domain 402 and could be realized as edge routers that are based on BGP. The domain 403 comprises three network elements 410 to 412, wherein the network element 410 is connected to the network elements 411 and 412 and the network element 411 is further connected to the network element 412. The network elements 410 and 412 are network elements at the edge of the domain 403 and could be realized as edge routers that are based on BGP.

An Element Management System (EMS) 413 to 421 is associated with each of the network elements 404 to 412. A Network Management System (NMS) 422 controls the EMSs 413 to 415, an NMS 423 controls the EMSs 416 to 418 and an NMS 423 controls the EMSs 419 to 421. A Service Management System (SMS) 425 communicates with the NMSs 422 to 424.

Hereinafter it will be described as how services can be utilized across several domains 401 to 403. In particular a path can be set up across such domains 401 to 403 considering these services. Such path can temporarily or statically be used for conveying data across the domains. The solution advantageously allows that the respective domains 401 to 403 maintain their internal mechanisms and are, e.g., free to decide which path to choose for inter-domain routing purposes. The control plane comprising the SMS, NMS and EMS hierarchy can (but does not have to) be used for control purposes beyond the borders of the respective domain.

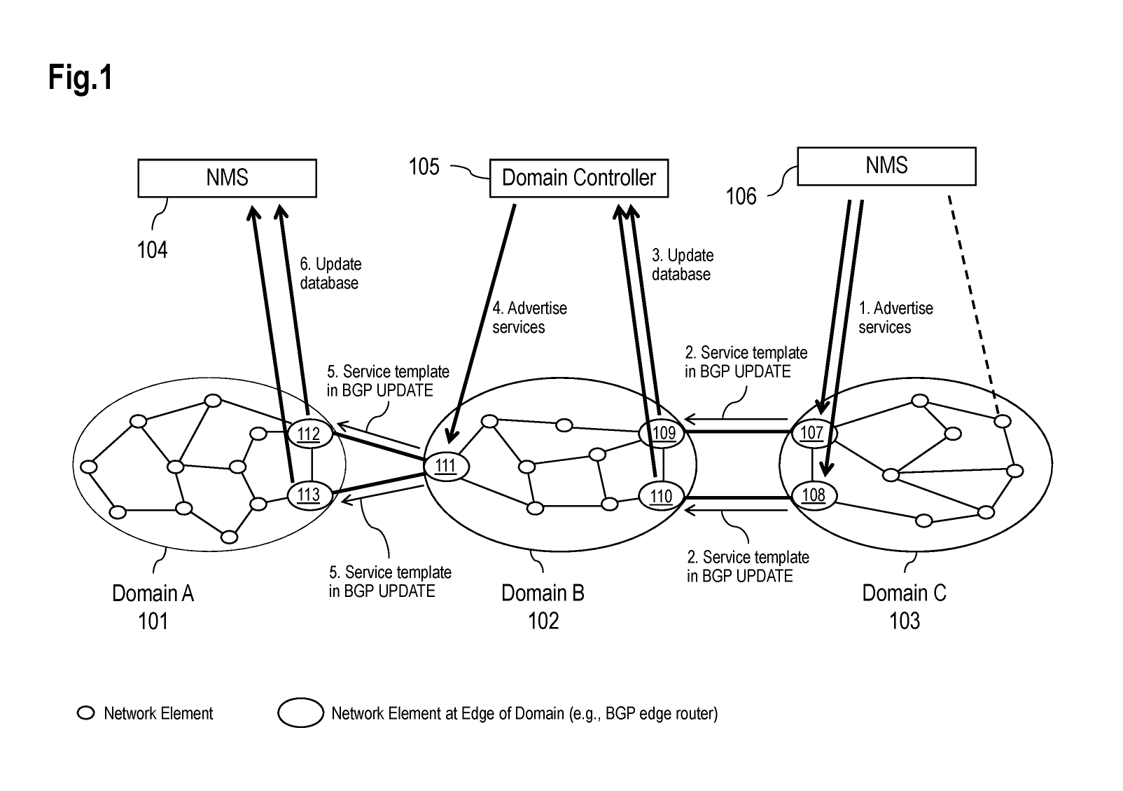

FIG. 1 shows a schematic diagram visualizing an advertising phase. The diagram comprises a domain A 101, a domain B 102 and a domain C 103, each with several network elements and routers that are deployed at the edge of each domain. The domain A 101 is controlled by an NMS 104, the domain B 102 is controlled by a domain controller 105 and the domain C 103 is controlled by a NMS 105. The domain A 101 and the domain C 103 can be connected via the domain B 102.

FIG. 1 visualizes how the domain C 103 advertises its services to the domain A 101 via the domain B 102. This can be achieved by the following steps (the numerals refer to the respective steps also shown in FIG. 1):

1. The NMS 106 advertises the services of the domain C 103 to edge nodes 107, 108 of the domain C 103.
2. The edge nodes 107, 108 convey a service template (via a BGP UPDATE message) to edge nodes 109, 110 of the domain B 102.
3. The edge nodes 109, 110 of the domain B 102 initiate a database update at the domain controller 105.
4. The domain controller 105 advertises the services of the domain C 103 to an edge node 111 of the domain B 102.
5. The edge node 111 conveys a service template via a BGP UPDATE message to an edge node 112 and to an edge node 113 of the domain A 101.
6. The edge nodes 112, 113 initiate a database update at the NMS 104.

As an example, the BGP UPDATE message can be extended with an optional and non-transitive attribute called “eBGP service” so that it can carry service templates, TE-path request templates and/or request accept or request reject templates from adjacent domains. These templates may carry detailed information regarding the service offered, requested, or accepted/rejected via a specific BGP router on its border (also referred to as edge node). Elements such as a destination information, a price information, and/or one or more QoS attributes such as bandwidth, delay and/or delay jitter can be included in the template.

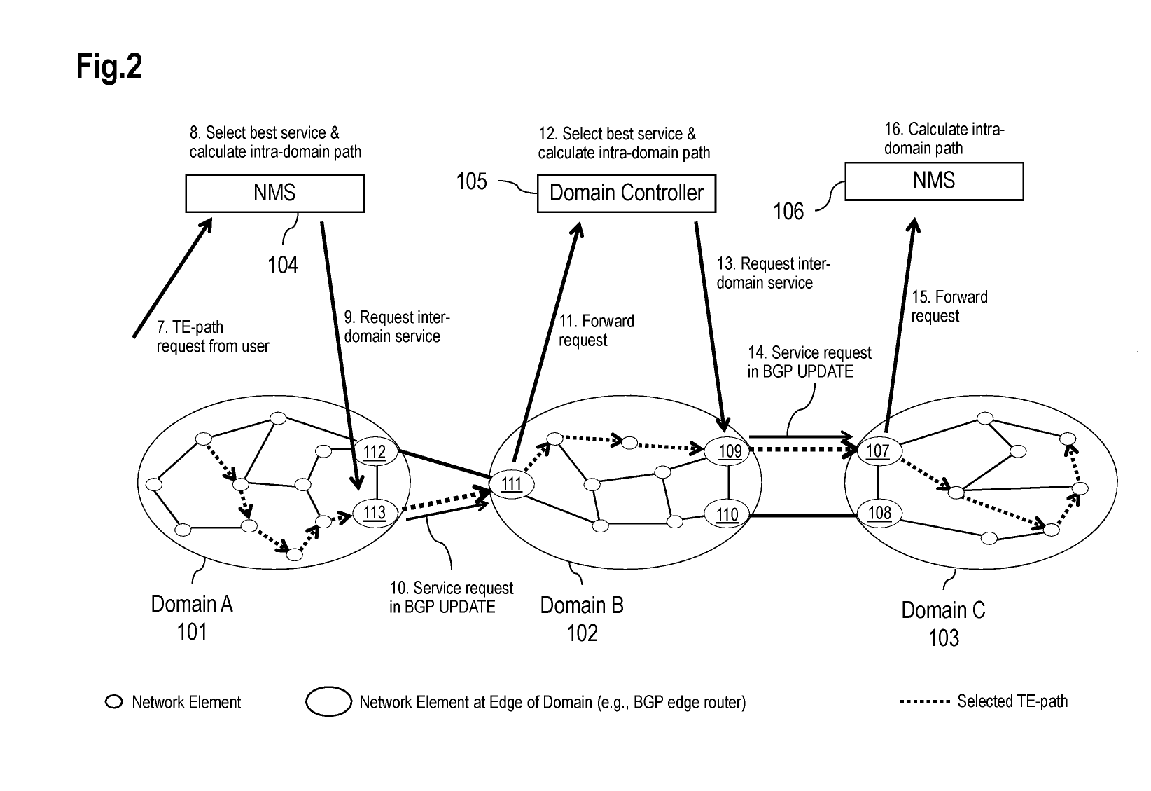

FIG. 2 shows a schematic diagram visualizing a service requesting phase and a path calculation phase that may follow after the steps as shown and explained with regard to FIG. 1. With regard to the components shown in FIG. 2 reference is made to FIG. 1 and the explanations provided above.

Hence, once at least one service template has been advertised from at least one adjacent domain to the local domain, the following steps may be conducted (the numerals refer to the respective steps also shown in FIG. 2):
7. A local user at the domain A 101 may request an inter-domain TE-path, e.g., by using a client interface on a NMS 104 or a universal network interface (UNI) if an intra-domain control plane is present. The request may be directed to a Central Control Entity (CCE), e.g., an SMS, an NMS or a domain controller, which holds information about local topology with TE constraints, current reservations and available inter-domain services. The CCE may calculate multi constrained TE-paths or query a path from a PCE.
8. If according to the locally maintained information the inter-domain path request can be fulfilled (i.e. the service requested and the required resources are available), an intra-domain path is calculated and resources can be reserved.
9. A suitable (e.g., optimal) edge node 113 (border BGP router) and the adjacent domain B 102 are selected; a request for an inter-domain service is conveyed to said edge node 113.
10. A service request, e.g. for an inter-domain TE-path, is conveyed via a BGP UPDATE message from the edge node 113 to the edge node 111 of the domain B 102. This BGP UPDATE message may advertise a requestor in a Network Layer Reachability Information field and it may specify a path request in another attribute that indicates which previously advertised service this domain would like to use.
11. The edge node 111 (e.g., a BGP router at the edge of the domain B 102) receives the service request and forwards it to its local control entity, i.e. the domain controller 105, for further processing.
12. The domain controller 105 selects the best service pursuant to the service request and determines an intra-domain path across the domain B 102. Resources may be reserved accordingly.
13. A request for an inter-domain service is sent from the domain controller 105 to a suitable edge node 109.
14. A service request is conveyed via a BGP UPDATE message from the edge node 109 to the edge node 107 of the domain C 103, which in the exemplary scenario of FIG. 2 is the destination domain.
15. The edge node 107 receives the service request and forwards it to its local control entity, i.e. the NMS 106, for further processing.
16. The NMS 106 calculates and selects the intra-domain path across the domain C 103.

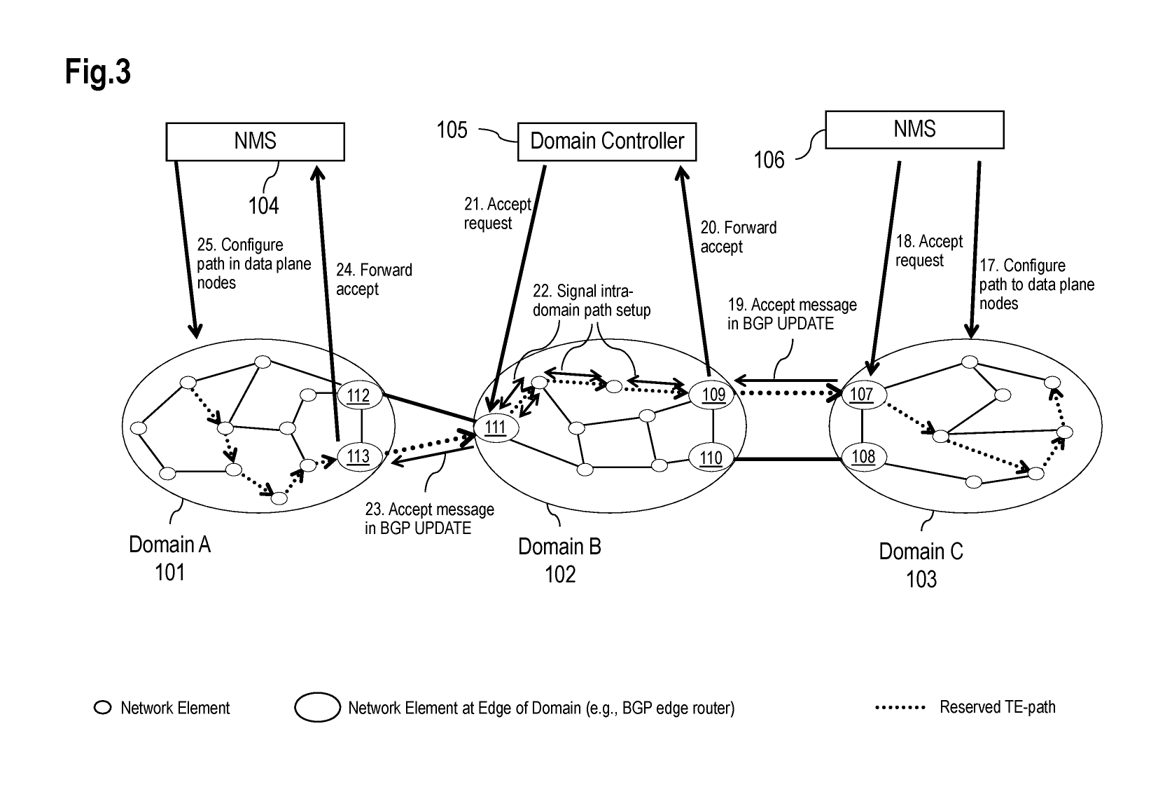

FIG. 3 shows a schematic diagram visualizing a service acceptance phase and a path setup phase that may follow after the steps as shown and explained with regard to FIG. 2. With regard to the components shown in FIG. 3 reference is made to FIG. 1, FIG. 2 as well as the explanations provided above.

Hence, after the step No.16 above, the following steps may be conducted (the numerals refer to the respective steps also shown in FIG. 3):
17. The NMS 106 sets up the intra-domain path across the domain C 103 by applying the path to the nodes of the data plane.
18. The NMS 106 generates a message to accept the request and conveys it to the edge node 107.
19. The edge node 107 conveys an accept message via a BGP UPDATE message toward the edge node 109.
20. The edge node 109 forwards the message received from the edge node 107 towards the domain controller 105.
21. The domain controller 105 generates a message to accept the request and conveys it to the edge node 111.
22. An intra-domain path is signaled and set up within the domain B 102.
23. The edge node 111 conveys an accept message via a BGP UPDATE message toward the edge node 113 of the domain A 101.
24. The edge node 113 forwards the message received from the edge node 111 towards the NMS 104.
25. The NMS 104 sets up the intra-domain path across the domain A 101 by applying the path to the nodes of the data plane.

Hence, the accept message to the service request (conveyed as shown in FIG. 2) is sent back via the same domain chain the service request was received. Along the path, each domain sets up its intra-domain path and the local side of each inter-domain hop. Finally, when the requestor domain A 101 receives the accept message, the path creation is finished and the path is ready to be used. Thus the NMS 104 can inform the user that requested the path of the successful setup and enable the usage of the path (not shown in the figures).

If a failure occurs during creation of the path, e.g., if an intra-domain path cannot be calculated for some domain or a service offered is outdated or a subsequent domain does not reply quickly enough, a reject message can be sent instead of the accept message. Then, each domain releases the resources reserved and, if required, the unavailable service can be removed from the databases. If the originating domain can find a next best route candidate, it can try to establish a new path without consulting the requesting user. As an option, the services offered can be verified (e.g. the price for the connection) with the user prior to establishing the path.

It is noted that the path can be set up differently within each domain along a single inter-domain path.

According to the example shown in FIG. 1 to FIG. 3, the domains A and C each sets up the intra-domain path via the NMS (Management plane) and domain B sets up its intra-domain path by using a signaling protocol like e.g. RSVP-TE, i.e. via a control plane. Although the NMS or a similar single control element with a TE database and an ability to calculate multi-domain multi constrained TE-paths is available and can be used, a domain owner may pursue a different approach for determining intra-domain paths. A domain owner could, e.g., use an extended OSPF-TE to distribute intra-domain TE information and information about services that adjacent domains are willing to provide (e.g., sell) along with normal topology information. The intra-domain part of the path calculation could then be done by an ingress domain router (at an entry-point of the domain). Depending on size and complexity of the domain topology, this ingress domain router may require a significant amount of computation power. Within the domain, a distributed path selection method [see, e.g.: Zhenjiang Li, Garcia-Luna-Aceves, J. J., A distributed approach for multi-constrained path selection and routing optimization. Proceedings of the 3rd international conference on Quality of service in heterogeneous wired/wireless networks, SESSION: Quality of service in wireline networks, Article No. 36, 2006] could be used as an option.

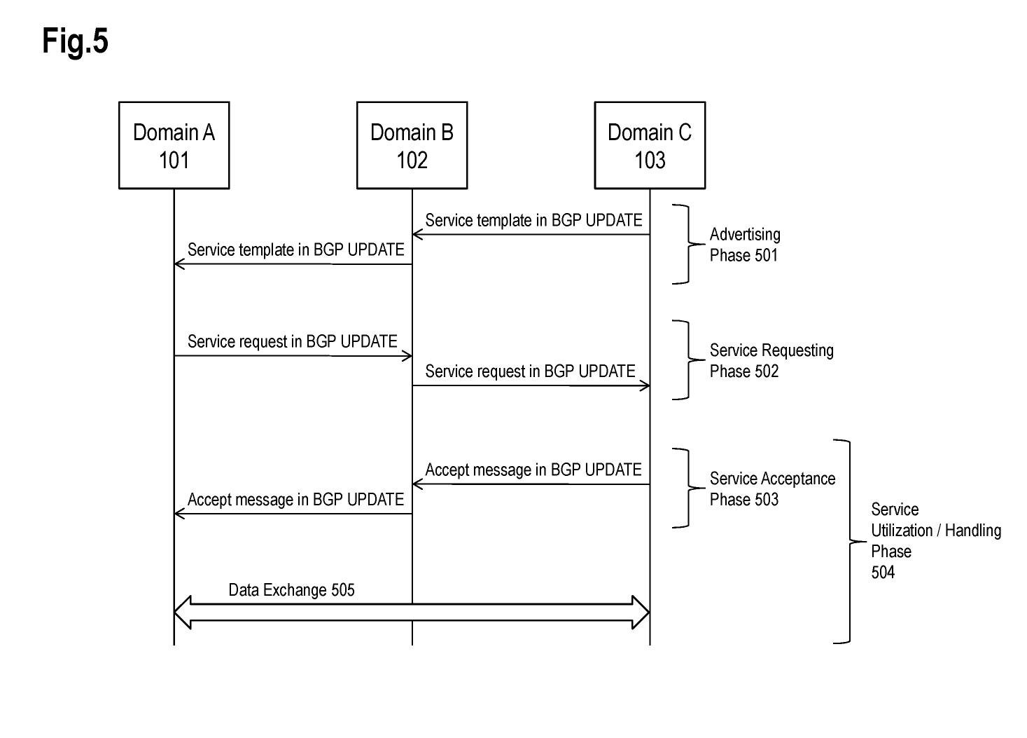

FIG. 5 shows a schematic message chart visualizing the domains 101 to 103 according to FIG. 1, FIG. 2 and FIG. 3.

In an advertising phase 501 a service template is conveyed across the domains, in the example shown from the domain C 103 via the domain B 102 to the domain A 101. The service template can be transferred utilizing a (modified) BGP UPDATE message.

In a service requesting phase 502, the domain A 101 conveys a service request (template) via the domain B 102 to the domain C 103. The service request template can be embedded in a (modified) BGP UPDATE message.

In a service utilization or service handling phase 504, the service requested could be accepted providing an accept message (template) from the domain C 103 via the domain B 102 to the domain A 101. This accept template can be conveyed via a (modified) BGP UPDATE message. Accepting the service offered is summarized in FIG. 5 as a service acceptance phase 503. It is noted, however, that the service may (for various reasons) be rejected, which also falls in the service handling phase 504, but triggers a different message, e.g., a reject message that is conveyed accordingly.

In case the accept message is successfully delivered to the domain A 101, the service can be used via a path that is set up, which is indicated by a data exchange 505 between the domain A 101 and the domain C 103.

The design of the eBGP service-attribute may depend on, e.g., what kind of a business model is chosen and as how templates are utilized.

Hereinafter, some examples are provided. Every type of template may preferably carry enough information to specify the service or request in detail and at the same time, the template might be small enough to fit into a block so that it can be conveyed with a BGP UPDATE message. The size of a single BGP UPDATE message may in particular comprise 4096 octets. If this is regarded a major limitation, the template(s) can be split into several messages.

The examples are partially based on ETNA [BGU, BT, Ethos, NSN, TKK, Ethernet Transport Networks, Architectures of Networking, WP2 Network Architecture, 31.12.2008; available at http://www.ict-etna.eu/documents/ETNA WP2 Network and Service Architecture—D2.1 R2—Issue 2.pdf].

All templates may preferably have a portion that defines parameters of a service offered. There may be different templates, e.g.,
for advertising a transit service or an access service,
for requesting a previously advertised service or
for responding to (i.e. utilizing or handling) a request.

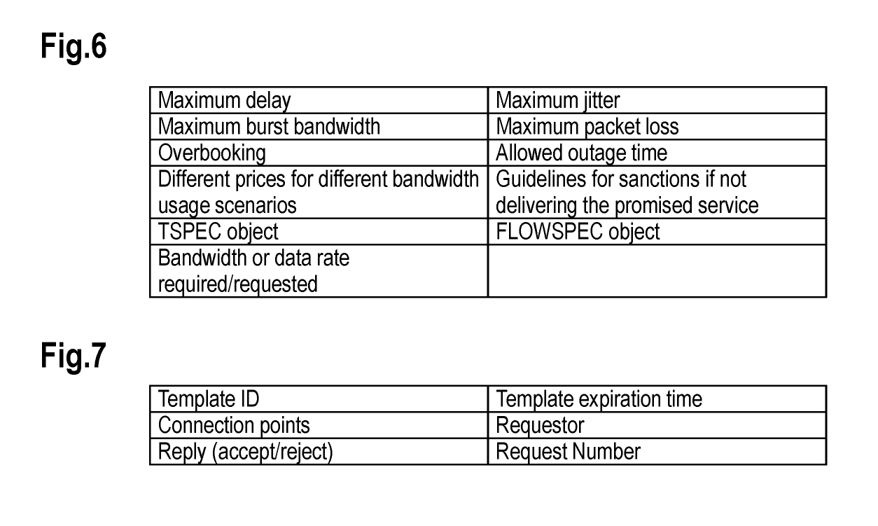

FIG. 6 shows a table comprising an exemplary template with information of a service request or a service offer. The TE and service parameters (e.g., a price) can be included in the service request or offer, which may also contain additional information about the service request or offer.

A single template could comprise several service offers or service requests. If the template reaches the limit of the size of the BGP UPDATE message, service offers or requests can be split into separate templates and/or messages.

It is also an option that the template comprises information regarding traffic characteristics of a service request or a service offer.
Such traffic characteristics may comprise a TSPEC object that carries information about traffic generated at a data source. This TSPEC object may carry traffic information usable by either guaranteed or controlled-load QoS control services. For details about such TSPEC object, reference is made to RFC 2210, “The Use of RSVP with IETF Integrated Services”, chapter 3.1.
Also, traffic characteristics may comprise a FLOWSPEC object that carries information that may be useful to make reservation requests from the receiver(s) into the network. This may include an indication which QoS control service is being requested, and parameters needed for that service. For details about such FLOWSPEC object, reference is made to RFC 2210, chapter 3.2.
Traffic characteristics may comprise a bandwidth and/or data rate information.

Transport, access, request and response templates may also comprise an identifier (ID) and/or an expiration time of the service template. Within the transport template, connection points, e.g., edge nodes or BGP routers can be identified. In an access template identity information may be provided that indicates to where an end host can be mapped. It is noted that aggregation information or other kind of information compression mechanisms could be applied. Such aggregation information may comprise information regarding aggregated multi-constrained paths. If different areas of a domain are advertized in more abstract service offers, some additional communication could be required to confirm that the actual level of QoS is accepted.

Request templates may have information about the requestor and a request number as well as service details that are requested (e.g., purchased). While the request is conveyed across domains, it may change its form and appearance like a request to a specific service offer each domain sends to its neighbor. An accept or reject template can otherwise be similar to the service request template, but it may have an accept or reject value set to some (e.g., HTTP style) status code indicating the reason of the decision.

FIG. 7 shows a table comprising exemplary fields of a template. If a utilization of a certain template does not require at least one field, its value can be set to zero. E.g., for a service advertisement, the values of a requestor, reply and request number fields are each set to “0” and for a request template only the reply field can be set to “0”. In order to explicitly delete an existing service offer, a similar template could be sent to the neighbor with an expiration value set to “0”. An empty template could be sent in order to query what services are currently offered by a neighbor. The answer to such a query may have the reply value set to a value other than “0” and the requestor and request number fields each is set to “0”.

An existing BGP definition can be amended by using a TE-attribute in a BGP message as suggested in this solution. Such BGP attribute may yet be optional and non-transitive, hence the use of it is not required according to BGP specifications and it will not be sent further to other domains in case it is not recognized.

When a BGP router recognizes the BGP attribute, it either may forward it to a CCE or handles the message itself depending on how the path calculation and allocation is done in this domain. The BGP may not forward the attribute to any other BGP router, be it iBGP or eBGP, because this BGP router may only advertise services it is directly selling. Even when using a distributed mechanism for TE-path calculation, only the information inside the template may be distributed to other routers. Following this logic, the respective domain which receives a service template is responsible to take into account the (e.g., traffic) characteristics and expenses of an inter-domain link.

To see if a peering eBGP router supports non-default BGP functions, a method called capability negotiations can be conducted (see RFC 3392, “Capabilities Advertisement with BGP-4”). This can be performed when routers initially make a peering connection or it can be performed later on, which enables the use of new features without any disturbance to the routing infrastructure. By using this feature, TES-BGP can be taken into service incrementally allowing only adjacent early adapters to benefit from it.

The solution presented herein in particular has the advantage that the domains providing inter-domain services remain uncoupled, i.e. they may independently maintain their internal processing, e.g., intra-domain path calculation and/or each domain may decide which CCE to use.

Another advantage is the flexibility of the approach presented, which allows implementing the functionality in an existing network by updating components of the network, e.g., the edge routers of the domains.

It is to be understood that the above description is illustrative of the invention and is not to be construed as limiting the invention. Especially, the exemplary description using the three domain model should not be considered as limiting. Various modifications and applications employing only two or more than three domains in various configurations may occur to those skilled in the art without departing from the true spirit and scope of the invention as defined by the appended claims.

### List of Abbreviations:

BGP Border Gateway Protocol
CCE Central Control Entity
DC Domain Controller
eBGP External BGP
EMS Element Management System
E-NNI External Network to Network Interface
iBGP Internal BGP
MTOSI Multi-Technology Operations System Interface
NMS Network Management System
OSPF-TE Open Shortest Path First—Traffic Engineering
PCE Path Computation Element
QoS Quality of Service
RSVP-TE Resource reservation protocol - Traffic Engineering
SLA Service Level Agreement
SMS Service Management System
TE Traffic Engineering
TES-BGP Traffic Engineering Service extension to Border Gateway Protocol
UNI User Network Interface

1. A method for conveying data across at least two domains,
wherein at least one service is advertised across the at least two domains;
wherein the at least one service is requested across the at least two domains;
wherein the at least one service is utilized across the at least two domains.

2. The method according to claim 1, wherein the at least one service is utilized across the at least two domains by accepting the request directed towards the at least one service and by configuring a path across the network elements within each domain and between the domains.

3. The method according to claim 1, wherein the at least one service is advertised, requested and/or utilized by conveying messages of an inter-domain routing protocol between the at least two domains.

4. The method of claim 3, wherein the messages of the inter-domain routing protocol specify the at least one service using a service template.

5. The method according to claim 3, wherein the inter-domain routing protocol is based on a border gateway protocol.

6. The method according to claim 5, wherein the messages of the inter-domain routing protocol are BGP UPDATE messages.

7. The method according to claim 1, wherein
the at least one service is advertised by a control entity of a first domain via at least one edge node of the first domain to at least one first edge node of a second domain;
the at least one first edge node of the second domain informs a control entity of the second domain about the at least one advertised service from the first domain;
the control entity of the second domain advertises the at least one service via at least one second edge node of the second domain to at least one edge node of a third domain;
the at least one edge node of the third domain informs a control entity of the third domain about the at least one advertised service from the first domain.

8. The method according to claim 7, wherein
a path request is received by the control entity of the third domain;
a service of the at least one advertised service is selected and a path across the third domain is determined by the control entity of the third domain;
a service request is conveyed by the control entity of the third domain via the at least one edge node to the at least one second edge node of the second domain;
the service request is forwarded from the at least one second edge node of the second domain to a control entity of the second domain;
a service is selected at the control entity of the second domain and a path across the second domain is determined by the control entity of the second domain;
a service request is conveyed by the control entity of the second domain via the at least one first edge node of the second domain to the at least one edge node of the first domain;
the service request is forwarded from the at least one edge node of the first domain to a control entity of the first domain;
the control entity of the first domain determines a path across the first domain.

9. The method according to claim 8, wherein
an accept service request is conveyed by the control entity of the first domain via the at least one edge node of the first domain to the at least one first edge node of the second domain;
the at least one first edge node of the second domain forwards the accept service request to a control entity of the second domain;
an accept service request is conveyed by the control entity of the second domain via the at least one second edge node of the second domain to the at least one edge node of the third domain;
the at least one edge node of the third domain forwards the accept service request to a control entity of the third domain.

10. The method according to claim 4, wherein the service template comprises at least one of the following:
a destination information;
price or cost information;
channel characteristics;
bandwidth information;
information regarding the service or quality of service provided or requested;
information regarding a domain;
delay information;
delay jitter information;
traffic information.

11. The method according to claim 8, wherein the intra-domain path in the first domain, in the second domain and in the third domain is set up via the respective control entity or via a signaling protocol.

12. The method according to claim 7, wherein the control entity is at least one of the following:
a network management system,
an element management system,
a service management system,
a domain controller.

13. A device for conveying data across at least two domains, comprising a processing unit that is arranged
for advertising at least one service across the at least two domains,
for utilizing the at least one service advertised across the at least two domains pursuant to a service request.

14. A device according to claim 13, wherein the processing unit is arranged to execute the method steps of at least one of a control entity of a first, a second, or a third domain.

15. A communication system comprising a first domain, a second domain and a third domain,
wherein at least one service is advertised by the first domain to the third domain via the second domain;
wherein the third domain requests the at least one service or a portion thereof from the first domain via the second domain;
wherein the at least one service requested is accepted or denied by the first domain via the second domain.

16. A computer program product, stored on a non-volatile storage medium and loadable into a memory of a digital computer, comprising software code portions to cause the computer to perform the steps of any of the methods according to claim 1.
